(19) United States
(12) Patent Application Publication
(10) Pub. No.: US 2025/0267500 A1
(43) Pub. Date: Aug. 21, 2025

(54) POLE PROXIMITY MANAGEMENT FOR MOBILE NODES IN WIRELESS COMMUNICATION NETWORKS

(71) Applicant: Cisco Technology, Inc., San Jose, CA (US)

(72) Inventors: Gaetano CATALLI, Firenze (IT); Amine CHOUKIR, Lausanne (CH); Domenico FICARA, Essertines-sur-Yverdon (CH); Carmine BENEDETTO, Pisa (IT); Pascal THUBERT, Roquefort les Pins (FR); Alessandro ERTA, Licciana Nardi (IT); Luca BISTI, Grosseto (IT); Francesco BASILE, Pisa (IT)

(73) Assignee: Cisco Technology, Inc., San Jose, CA (US)

(21) Appl. No.: 18/581,573

(22) Filed: Feb. 20, 2024

(51) Int. Cl. H04W 28/02; H04W 36/00; H04W 76/15

(52) U.S. Cl. CPC H04W 28/0226; H04W 28/0231; H04W 36/0069; H04W 76/15

(57) ABSTRACT

In one embodiment, a method described herein includes identifying, by a device, an area of reduced wireless communication coverage for a primary wireless communication channel utilized for wireless communication by a mobile node during transit of the mobile node along a predicted path and enabling, by the device and in preparation of the mobile node entering the area, a secondary wireless communication channel configured to provide a threshold level of wireless communication coverage for wireless communication by the mobile node during transit through the area along the predicted path. The method further includes returning, by the device and based on the mobile node exiting the area, to the primary wireless communication channel to provide wireless communication by the mobile node.

### TECHNICAL FIELD

The present disclosure relates generally to computer networks, and, more particularly, to pole proximity management for mobile nodes in wireless communication networks.

### BACKGROUND

Mobile nodes, such as those found on trains and other moving vehicles, are becoming increasingly ubiquitous. Indeed, many public transportation systems now offer Internet connectivity, as an added benefit to their passengers. To support such connectivity, base stations are often deployed along the path of travel (e.g., railway, road, etc.) at a certain height (e.g., on poles, tunnel walls, etc.).

Interestingly, a “key-hole” phenomenon has been observed in real-world implementations in subways that make use of a 2×2 multiple-input, multiple-output orthogonal frequency-division multiplexing (MIMO-OFDM) setup. Under this phenomenon, as the mobile node approaches a base station, performance actually decreases. More specifically, when the mobile node reaches a certain “key-hole entry point” at a certain distance to the base station, the received signal strength indicator (RSSI) and throughput have been observed to actually decrease until the node exits a key-hole exit point after passing the base station.

In order to address the key-hole problem, “pole banning”’ approaches have been introduced. In general, “pole banning” effectively bans a mobile node from using a particular base station. However, these approaches are usually based on the RSSI crossing a defined threshold, which can be difficult to configure and is often non-optimal. Further approaches may rely on the location of the mobile node and the relative distance between the mobile node and the base station, to control when a pole ban is enforced.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example communication network;

FIG. 2 illustrates an example network device/node;

FIG. 3 illustrates an example of the key-hole phenomenon;

FIG. 4 illustrates an example system for pole proximity management in accordance with one or more implementations of the disclosure; and

FIG. 5 illustrates an example simplified procedure for pole proximity management in accordance with one or more implementations of the disclosure.

### DESCRIPTION OF EXAMPLE EMBODIMENTS

### Overview

According to one or more embodiments of the disclosure, a device may identify an area of reduced wireless communication coverage for a primary wireless communication channel utilized for wireless communication by a mobile node during transit of the mobile node along a predicted path and enable, in preparation of the mobile node entering the area, a secondary wireless communication channel configured to provide a threshold level of wireless communication coverage for wireless communication by the mobile node during transit through the area along the predicted path. The device may return, based on the mobile node exiting the area, to the primary wireless communication channel to provide wireless communication by the mobile node.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

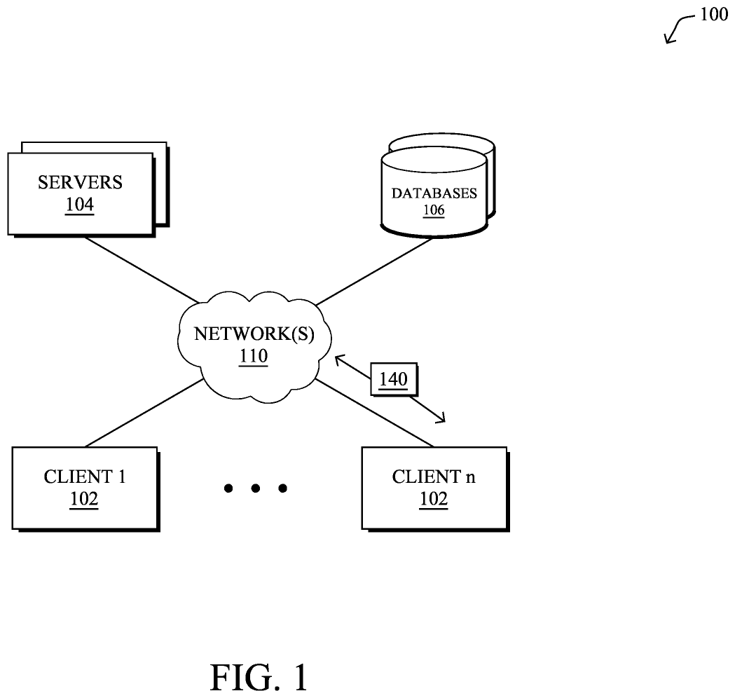

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

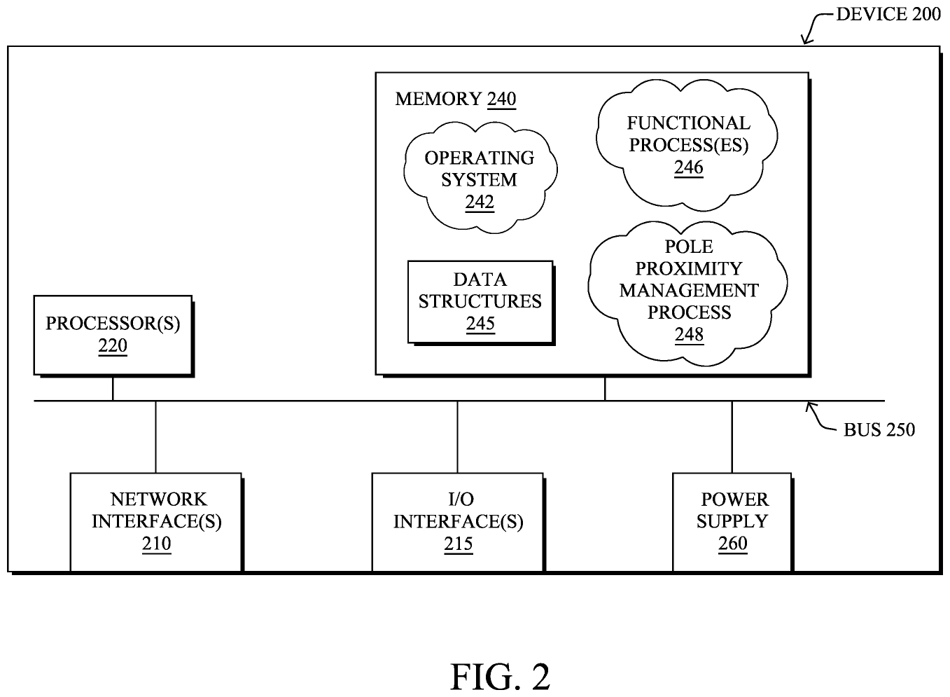

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise routing process 246 (e.g., routing services) and illustratively, a pole proximity management process 248, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

The routing process 246 may include instructions executable by processor 220 to perform functions provided by one or more routing protocols, such as proactive or reactive routing protocols as will be understood by those skilled in the art. These functions may, on capable devices, be configured to manage a routing/forwarding table (a data structure 245) including, e.g., data used to make routing/forwarding decisions. In particular, in proactive routing, connectivity is discovered and known prior to computing routes to any destination in the network, e.g., link state routing such as Open Shortest Path First (OSPF), or Intermediate-System-to-Intermediate-System (ISIS), or Optimized Link State Routing (OLSR). Reactive routing, on the other hand, discovers neighbors (i.e., does not have an a priori knowledge of network topology), and in response to a needed route to a destination, sends a route request into the network to determine which neighboring node may be used to reach the desired destination. Example reactive routing protocols may comprise Ad-hoc On-demand Distance Vector (AODV), Dynamic Source Routing (DSR), 6LoWPAN Ad Hoc On-Demand Distance Vector Routing (LOAD), DYnamic MANET On-demand Routing (DYMO), etc. Notably, on devices not capable or configured to store routing entries, routing process may consist solely of providing mechanisms necessary for source routing techniques. That is, for source routing, other devices in the network can tell the less capable devices exactly where to send the packets, and the less capable devices simply forward the packets as directed.

In general, pole proximity management process 248 includes computer-executable instructions executable by processor 220 to perform functions related to a mobile system roaming from one wireless access point to another. To this end, pole proximity management process 248 may operate in conjunction with the routing process 246, in some instances, to establish and maintain one or more label-switched paths (LSPs) between a mobile system and the backend infrastructure. An example protocol that uses label-switched paths is the Multiprotocol Label Switching (MPLS) protocol. In general, MPLS operates by appending an MPLS header to a packet that includes a label ‘stack.’ The label(s) in the stack are inserted by a label edge router (LER) based on the forwarding equivalence class (FEC) of the packet. Paths are also managed via the Label Distribution Protocol (LDP) or Resource Reservation Protocol-Traffic Engineering (RSVP-TE). Another protocol that pole proximity management process 248 may utilize is the Control and Provisioning of Wireless Access Points (CAPWAP) protocol.

In various embodiments, pole proximity management process 248 may utilize machine learning techniques, to perform the techniques described herein. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

Computational entities that rely on one or more machine learning techniques to perform a task for which they have not been explicitly programmed to perform are typically referred to as learning machines. In particular, learning machines are capable of adjusting their behavior to their environment. For example, a learning machine may dynamically make future predictions based on current or prior network measurements, may make control decisions based on the effects of prior control commands, etc.

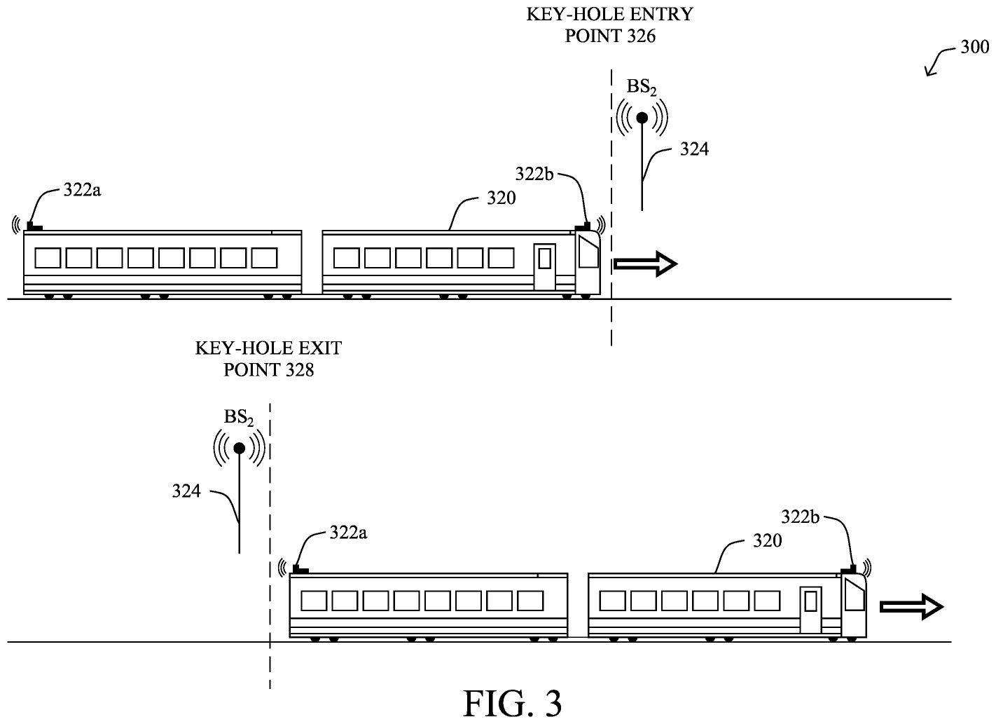

FIG. 3 illustrates an example of the key-hole phenomenon. As shown in the system 300 of FIG. 3, a train 320 that includes one or more nodes (e.g., the nodes 322a to 322b, which can be routers, client devices, mobile nodes, etc.) approaches a base station 324 (as illustrated in the top portion of FIG. 3). As the train 320 draws nearer to the base station 324, the key-hole entry point 326 is reached. As the train 320 passes the key-hole entry point 326, the received signal strength indicator (RSSI) and/or throughput experienced by the nodes 322a to 322b may decrease. Accordingly, the nodes 322a to 322b may not receive adequate signal from the base station 324 to operate.

This lowered RSSI and/or reduced throughput may continue until the train 320 reaches the key-hole exit point 328 (as illustrated in the lower portion of FIG. 3). Once the train 320 and/or the nodes 322a to 322b have exited the key-hole exit point 328, normal RSSI and/or throughput from the base station 324 may again be observed.

In general, the keyhole phenomenon (also referred to sometimes as the “pinhole” effect) is related to scenarios where rich scattering around the transmitter and receiver leads to low correlation of the signals, while other propagation effects, like diffraction or waveguiding, lead to a rank reduction of the transfer function matrix. As mentioned above, the key-hole phenomenon has been observed in real-world implementations, for example, in subways that make use of a 2×2 multiple-input, multiple-output orthogonal frequency-division multiplexing (MIMO-OFDM) setup, as well as other wireless configurations. When the key-hole phenomenon is observed, for example as the nodes 322a to 322b approach the base station 324, performance actually decreases, which may seem counterintuitive. More specifically, as shown in FIG. 3, when the node reaches a certain key-hole entry point (e.g., the key-hole entry point 326) at a certain distance to the base station 324, the RSSI and throughput have been observed to decrease until the nodes 322a to 322b exit the key-hole exit point 328 after passing the base station 324.

In order to address this issue, some approaches rely on “pole banning,” which effectively bans a mobile node (e.g., the nodes 322a to 322b) from using a particular base station (e.g., the base station 324). However, these approaches are generally based on the RSSI crossing a defined threshold, which can be difficult to configure and is often non-optimal. Further approaches may rely on the location of the mobile node and the relative distance between the mobile node and the base station, to control when a pole ban is enforced. However, these approaches may also be difficult to configure and/or non-optimal, and do not offer solutions for alternative communication mechanisms during pole banning, particularly on fast-moving mobile devices.

### —Pole Proximity Management—

As mentioned above, mobile nodes, such as those found on trains and other moving vehicles (e.g., conveyances), are becoming increasingly ubiquitous. Indeed, many public transportation systems now offer Internet connectivity as an added benefit to their passengers. To support such connectivity, base stations are often deployed along the path of travel (e.g., railway, road, etc.) at a certain height (e.g., on poles, tunnel walls, etc.). However, as discussed above, the key-hole phenomenon, which can lead to the pole banning problem discussed herein can have adverse effects on connectivity of these mobile nodes.

The techniques herein therefore seek to provide solutions to the key-hole phenomenon, and ensuing pole banning problem described above, that are simple to configure and/or are more optimal than, at minimum, the approaches discussed above. To this end, the techniques herein introduce a solution (e.g., a Wi-Fi 7-based solution) for the pole banning problem using Multi-Link Operations (MLO). In addition, the techniques herein address the pole proximity issue using multi-radio capabilities of a moving system, such as a train or other conveyance.

Specifically, according to one or more embodiments of the disclosure as described in detail below, a device may identify an area of reduced wireless communication coverage for a primary wireless communication channel utilized for wireless communication by a mobile node during transit of the mobile node along a predicted path and enable, in preparation of the mobile node entering the area, a secondary wireless communication channel configured to provide a threshold level of wireless communication coverage for wireless communication by the mobile node during transit through the area along the predicted path. The device may return, based on the mobile node exiting the area, to the primary wireless communication channel to provide wireless communication by the mobile node.

Illustratively, the techniques described herein may be performed by hardware, software, and/or firmware, such as in accordance with the pole proximity management process 248, which may include computer executable instructions executed by the processor 220 (or independent processor of network interfaces 210) to perform functions relating to the techniques described herein, e.g., in conjunction with routing processes described above.

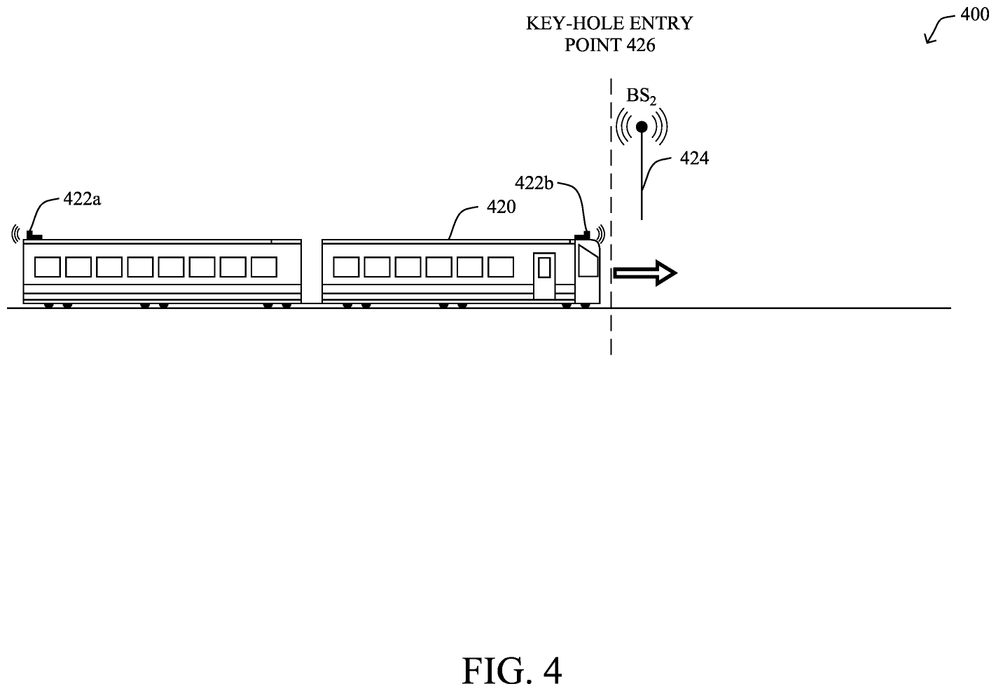

Operationally, FIG. 4 illustrates an example system for pole proximity management in accordance with one or more implementations of the disclosure. As shown in the system 400 of FIG. 4, a train 420 that includes one or more nodes (e.g., the nodes 422a to 422b, which can be routers, client devices, mobile nodes, etc.) approaches a base station 424. As the train 420 draws nearer to the base station 424, the key-hole entry point 426 is reached. It is noted that the train 420, the nodes 422a to 422b, the base station 424, and the key-hole entry point 426 can be analogous to the train 320, the nodes 322a to 322b, the base station 324, and the key-hole entry point 326 illustrated in FIG. 3, herein.

As will be appreciated, in previous generations of Wi-Fi, a station (or “STA”) is generally only able to communicate on one band, either the 2.4 GHz band, the 5 GHz band, or even, more recently, the 6 GHz band. As used herein, the term “STA” generally refers to a device that has the capability to use the 802.11 protocol. For example, a station may be a laptop, a desktop PC, PDA, access point, Wi-Fi phone, etc. Accordingly, the nodes 422a to 422b and/or the base station 424 may be referred to herein as a “STA.” A STA may be fixed, mobile, or portable.

In contrast to these previous generations of Wi-Fi, Wi-Fi 7 introduces Multi-Link Operation (MLO), which allows the STA to transmit and receive across channels in any of these bands, simultaneously. In general, Wi-Fi 7 operates according to the IEEE 802.11be protocol and exhibits a greater throughput than previous generations of Wi-Fi. Although some implementations are described in connection with Wi-Fi 7, it will be appreciated that the techniques described herein can be applicable to other standards, such as Wi-Fi 8, or future generations of Wi-Fi.

In accordance with the disclosure, this MLO capability can be leveraged opportunistically for example, in response to a pole ban scenario. In order to accomplish this, implementations herein provide that a STA, such as the nodes 422a to 422b can identify their location with respect to the base station 424 (e.g., the “pole”). Subsequent to identifying the location of the STA with respect to the pole, the STA can opportunistically enable additional links with different wireless technologies that work better or best at short ranges.

For example, in FIG. 4, when the train 420 approaches the key-hole entry point 426, a STA can enable an additional link or set of links, such as mmWave, 802.11ad, Li-Fi, etc. This can allow the STA to leverage one or more links while present within the key-hole of the pole (e.g., while the train 420 is in the area between the key-hole entry point 426 and the key-hole exit point 328 of FIG. 3). Once the STA leaves the key-hole, the STA can then switch back to using its primary Wi-Fi channel.

According to various implementations herein, determining when a mobile device is about to enter a key-hole, a pole ban, or generally an area of reduced wireless communication coverage for the primary wireless communication channel may be based on a number of factors. For instance, reduced coverage itself may be identified based on mapped signal properties or measured antenna properties of the area, or predictive signal modeling, assumed distances of coverage, or simply manual configuration of location boundaries. As such, knowing when a mobile node is approaching such an area of reduced coverage may be based on global positioning system/satellite (GPS) data, short range wireless communications (e.g., track-side beacons, NFC devices, bar code scans, etc.), or data from location monitoring systems generally integrated with a predicted path.

In some implementations, the dynamic (and opportunistic) selection of the alternate link or set of links can be made either locally by the STA itself (e.g., based on previously captured telemetry data), or the selection of the alternate link or set of links can be made in a centralized manner. In implementations in which the selection of the alternate link or set of links is made in a centralized manner, a controller could push such configurations to the STA. These configurations can be pushed on the fly or can be based on telemetry collected from other STAs over time and/or artificial intelligence algorithms, etc.

The implementations illustrated in FIG. 4 and described herein allow for the opportunistic enablement of MLO in situations where a pole-ban would be triggered. These techniques therefore allow for an improvement to RSSI and throughput, particularly in scenarios in which a pole-ban would be triggered. In addition, implementations herein allow for the secondary links that are opportunistically allocated to be “reserved” for such cases (e.g., in scenarios in which a pole-ban would be triggered and the opportunistic selection of the alternate link or set of links is enabled). This, among other features described herein can ensure reliability that is crucial in modern deployments.

In addition, leveraging multi-radio capability of state-of-the-art access points, MLO can be activated in the pole-proximity (e.g., in the area between the key-hole entry point 426 and the key-hole exit point 328 of FIG. 3) to increase the probability of packet delivery without unnecessary handovers from head to tail (and vice-versa) access points. In addition, more sophisticated schemes are contemplated herein, for example, schemes in which head and tail transmission are combined to facilitate the techniques described herein, such as for long trains or other vehicular convoys with multiple units traveling in tandem and thus at different locations in relation to the pole in question.

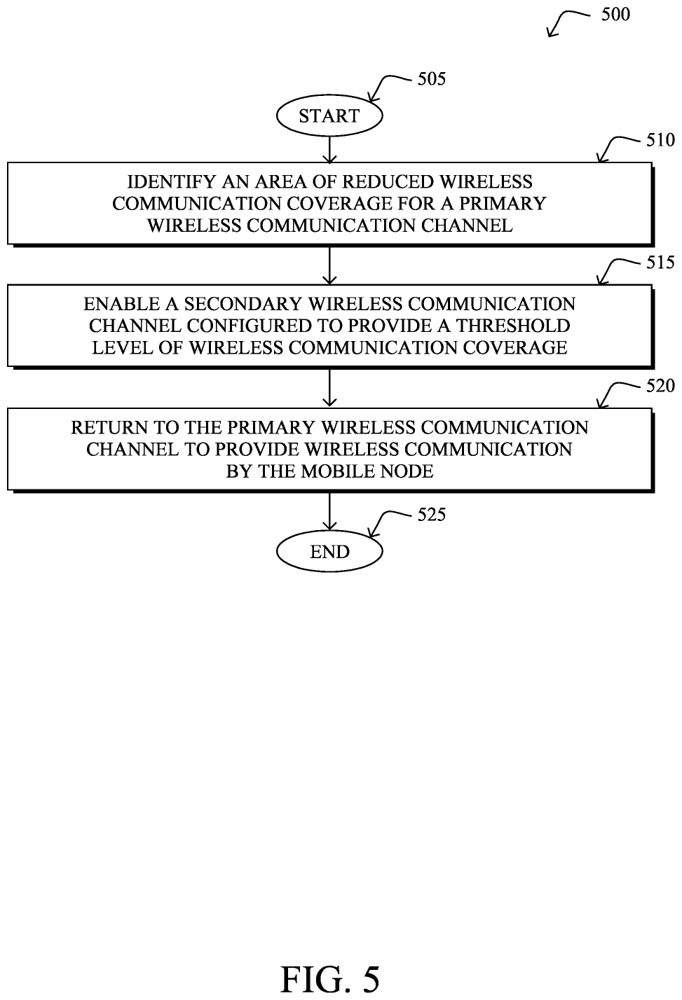

FIG. 5 illustrates an example simplified procedure for pole proximity management in accordance with one or more implementations of the disclosure. For example, a non-generic, specifically configured device (e.g., device 200) may perform procedure 500 (e.g., a method) by executing stored instructions (e.g., the pole proximity management process 248). The procedure 500 may start at step 505, and continues to step 510, where, as described in greater detail above, a device may identify an area of reduced wireless communication coverage for a primary wireless communication channel utilized for wireless communication by a mobile node during transit of the mobile node along a predicted path. In some implementations, the device can be the mobile node, although implementations are not so limited.

The procedure 500 may continue to step 515 where, as described in greater detail above, the device may, in preparation of the mobile node entering the area, enable a secondary wireless communication channel configured to provide a threshold level of wireless communication coverage for wireless communication by the mobile node during transit through the area along the predicted path. In some implementations, enabling the secondary wireless communication channel may include opportunistically enabling Multi-Link Operations (MLO) on the mobile node. Further, in some implementations, the secondary wireless communication channel can be enabled responsive to the mobile node being within a threshold proximity of a base station associated with the area of reduced wireless communication coverage.

As described herein, the mobile node can include multiple antennas. In such implementations, enabling of the secondary wireless communication channel involves utilizing a different set of antennas than those used for the primary wireless communication channel.

The secondary wireless communication channel can be associated with a distinct wireless communication technology than is utilized by the primary wireless communication channel. In such implementations, the distinct wireless communication technology can be selected from a group consisting of: millimeter wave (mmWave), light fidelity (Li-Fi), and 802.11ad. In addition to, or in the alternative, the secondary wireless communication channel can be reserved for use by the mobile node within the area of reduced wireless communication coverage for the primary wireless communication channel. Further, the secondary wireless communication channel can be selected from a pool of available channels based on environmental conditions and channel performance metrics, among other factors.

In some implementations, the mobile node can be part of a convoy of moving vehicles. In such implementations, enabling the secondary wireless communication channel includes coordinating wireless communications between a plurality of mobile nodes of the convoy to establish the secondary wireless communication channel via a different mobile node of the plurality of mobile nodes of the convoy located outside of the area. The convoy can be selected from a group consisting of: a train on a track, a collection of wheeled transport vehicles on a road, and/or a collection of autonomous vehicles on a specified path.

The procedure 500 may continue to step 520 where, as described in greater detail above, the device may, based on the mobile node exiting the area, return to the primary wireless communication channel to provide wireless communication by the mobile node.

In some implementations, the area of reduced wireless communication coverage for the primary wireless communication channel can be identified based on one or more of mapped signal properties associated with the area, measured antenna properties associated with the area, and/or predictive signal modeling. As mentioned above, the area of reduced wireless communication coverage along the predicted path can be based on wireless communication performance by one or more mobile nodes along a known repeated path. Further, in some implementations, a location of the mobile node relative to the area of reduced wireless communication coverage for the primary wireless communication channel can be identified based on one or more of global positioning system data associated with the mobile node, short range wireless communications associated with the mobile node, and/or data from location monitoring systems integrated with the predicted path.

The procedure 500 may end at step 525.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus includes one or more network interfaces to communicate with a network; a processor coupled to the one or more network interfaces and configured to execute one or more processes; and a memory configured to store a process that is executable by the processor. The process, when executed, is configured to: identify an area of reduced wireless communication coverage for a primary wireless communication channel utilized for wireless communication by a mobile node during transit of the mobile node along a predicted path; enable, in preparation of the mobile node entering the area, a secondary wireless communication channel configured to provide a threshold level of wireless communication coverage for wireless communication by the mobile node during transit through the area along the predicted path; and return, based on the mobile node exiting the area, to the primary wireless communication channel to provide wireless communication by the mobile node.

In still other implementations, a tangible, non-transitory, computer-readable medium storing program instructions that cause a device to execute a process comprising: identifying an area of reduced wireless communication coverage for a primary wireless communication channel utilized for wireless communication by a mobile node during transit of the mobile node along a predicted path; enabling, in preparation of the mobile node entering the area, a secondary wireless communication channel configured to provide a threshold level of wireless communication coverage for wireless communication by the mobile node during transit through the area along the predicted path; and returning, based on the mobile node exiting the area, to the primary wireless communication channel to provide wireless communication by the mobile node.

The techniques described herein, therefore, provide for pole proximity management. As discussed above, the techniques herein introduce a Wi-Fi 7-based solution for the pole banning problem using Multi-Link Operations (MLO). In addition, the techniques herein address the pole proximity issue using multi-radio capabilities of a moving system, such as a train or other conveyance.

Illustratively, the techniques described herein may be performed by hardware, software, and/or firmware, (e.g., an “apparatus”), and may include computer-executable instructions executed by one or more processors to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the operations and processes described herein.

While there have been shown and described illustrative implementations above it is to be understood that various other adaptations and modifications may be made within the scope of the implementations herein. For example, while certain implementations are described herein with respect to certain types of computing architectures in particular, the techniques are not limited as such and may be used with any computing architecture, generally, in other implementations. In addition, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
identifying, by a device, an area of reduced wireless communication coverage for a primary wireless communication channel utilized for wireless communication by a mobile node during transit of the mobile node along a predicted path;
enabling, by the device and in preparation of the mobile node entering the area, a secondary wireless communication channel configured to provide a threshold level of wireless communication coverage for wireless communication by the mobile node during transit through the area along the predicted path; and
returning, by the device and based on the mobile node exiting the area, to the primary wireless communication channel to provide wireless communication by the mobile node.

2. The method of claim 1, wherein enabling the secondary wireless communication channel includes opportunistically enabling Multi-Link Operations (MLO) on the mobile node.

3. The method of claim 1, wherein the secondary wireless communication channel is associated with a distinct wireless communication technology than is utilized by the primary wireless communication channel and wherein the distinct wireless communication technology is selected from a group consisting of: millimeter wave (mmWave), light fidelity (Li-Fi), and 802.11ad.

4. The method of claim 1, wherein the secondary wireless communication channel is reserved for use by the mobile node within the area of reduced wireless communication coverage for the primary wireless communication channel.

5. The method of claim 1, wherein the area of reduced wireless communication coverage for the primary wireless communication channel is identified based on one or more of mapped signal properties associated with the area, measured antenna properties associated with the area, or predictive signal modeling.

6. The method of claim 1, wherein a location of the mobile node relative to the area of reduced wireless communication coverage for the primary wireless communication channel is identified based on one or more of global positioning system data associated with the mobile node, short range wireless communications associated with the mobile node, or data from location monitoring systems integrated with the predicted path.

7. The method of claim 1, wherein the mobile node is part of a convoy of moving vehicles, and wherein enabling the secondary wireless communication channel includes coordinating wireless communications between a plurality of mobile nodes of the convoy to establish the secondary wireless communication channel via a different mobile node of the plurality of mobile nodes of the convoy located outside of the area.

8. The method of claim 7, wherein the convoy is selected from a group consisting of: a train on a track, a collection of wheeled transport vehicles on a road, and a collection of autonomous vehicles on a specified path.

9. The method of claim 1, wherein the secondary wireless communication channel is enabled responsive to the mobile node being within a threshold proximity of a base station associated with the area of reduced wireless communication coverage.

10. The method of claim 1, wherein the mobile node includes multiple antennas and enabling of the secondary wireless communication channel involves utilizing a different set of antennas than those used for the primary wireless communication channel.

11. The method of claim 1, further comprising:
selecting the secondary wireless communication channel from a pool of available channels based on environmental conditions and channel performance metrics.

12. The method of claim 1, wherein the device is the mobile node.

13. The method of claim 1, wherein identifying the area of reduced wireless communication coverage along the predicted path is based on wireless communication performance by one or more mobile nodes along a known repeated path.

14. An apparatus, comprising:
one or more network interfaces to communicate with a network;
a processor coupled to the one or more network interfaces and configured to execute one or more processes; and
a memory configured to store a process that is executable by the processor, the process, when executed, configured to:
identify an area of reduced wireless communication coverage for a primary wireless communication channel utilized for wireless communication by a mobile node during transit of the mobile node along a predicted path;
enable, in preparation of the mobile node entering the area, a secondary wireless communication channel configured to provide a threshold level of wireless communication coverage for wireless communication by the mobile node during transit through the area along the predicted path; and
return, based on the mobile node exiting the area, to the primary wireless communication channel to provide wireless communication by the mobile node.

15. The apparatus of claim 14, wherein enabling the secondary wireless communication channel includes opportunistically enabling Multi-Link Operations (MLO) on the mobile node.

16. The apparatus of claim 14, wherein the secondary wireless communication channel is associated with a distinct wireless communication technology than is utilized by the primary wireless communication channel and wherein the distinct wireless communication technology is selected from a group consisting of: millimeter wave (mmWave), light fidelity (Li-Fi), and 802.11ad.

17. The apparatus of claim 14, wherein the secondary wireless communication channel is reserved for use by the mobile node within the area of reduced wireless communication coverage for the primary wireless communication channel.

18. The apparatus of claim 14, wherein the area of reduced wireless communication coverage for the primary wireless communication channel is identified based on one or more of mapped signal properties associated with the area, measured antenna properties associated with the area, or predictive signal modeling.

19. The apparatus of claim 14, wherein a location of the mobile node relative to the area of reduced wireless communication coverage for the primary wireless communication channel is identified based on one or more of global positioning system data associated with the mobile node, short range wireless communications associated with the mobile node, or data from location monitoring systems integrated with the predicted path.

20. A tangible, non-transitory, computer-readable medium storing program instructions that cause a device to execute a process comprising:
identifying an area of reduced wireless communication coverage for a primary wireless communication channel utilized for wireless communication by a mobile node during transit of the mobile node along a predicted path;
enabling, in preparation of the mobile node entering the area, a secondary wireless communication channel configured to provide a threshold level of wireless communication coverage for wireless communication by the mobile node during transit through the area along the predicted path; and
returning, based on the mobile node exiting the area, to the primary wireless communication channel to provide wireless communication by the mobile node.
